(19) United States
(12) Patent Application Publication
(10) Pub. No.: US 2006/0063041 A1
(43) Pub. Date: Mar. 23, 2006

(54) Magnetic recording medium

(75) Inventors: Shinji Tsujimoto, Kanagawa (JP); Hiroshi Hashimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/231,934

(22) Filed: Sep. 22, 2005

(30) Foreign Application Priority Data
Sep. 22, 2004 (JP) 2004-275080

(51) Int. Cl. G11B 5/706

(52) U.S. Cl. 428/844.6; 428/842

(57) ABSTRACT

A magnetic recording medium is provided that includes a support, and at least one magnetic layer provided above the support, the magnetic layer including a ferromagnetic powder dispersed in a binder, the binder of the magnetic layer including a binder that is obtained by a reaction between a hyperbranched polyester and an isocyanate curing agent, and the magnetic layer having an indentation hardness of 392 to 981 MPa (40 to 100 kgf/mm²).

### BACKGROUND OF THE INVENTION

### Field of the Invention

The present invention relates to a magnetic recording medium.

In general, with the demand for higher recording density of magnetic recording media for computer use, etc., it is necessary to yet further improve electromagnetic conversion characteristics, and it is important to make a ferromagnetic powder finer, the surface of the medium ultra smooth, etc. Furthermore, due to a decrease in track width accompanying the higher recording density, there is the problem that dropouts are caused even by small indentations on the magnetic layer.

With regard to finer magnetic substances, a recent magnetic substance employs a ferromagnetic metal powder of 0.1 μm or less or a fine ferromagnetic hexagonal ferrite powder having a plate size of 40 nm or less. In the case of a multilayer structure in which a magnetic layer is provided as an upper layer above a non-magnetic lower layer provided on the surface of a support, in order to highly disperse a fine non-magnetic powder used for the non-magnetic layer or the fine magnetic substance, a magnetic recording medium has been proposed that comprises a polycarboxylic acid or an anhydride thereof having a molecular weight of equal to or less than 300 in a magnetic layer (ref. JP-A-9-212847; JP-A denotes a Japanese unexamined patent application publication). There has also been proposed a magnetic recording medium comprising an organophosphorous compound in a magnetic layer (ref. JP-A-2001-338414).

### BRIEF SUMMARY OF THE INVENTION

It is an object of the present invention to provide a magnetic recording medium that can suppress dropouts while achieving a high recording density.

The object of the present invention has been attained by (1) to (3) below.

(1) A magnetic recording medium comprising a support, and at least one magnetic layer provided above the support, the magnetic layer comprising a ferromagnetic powder dispersed in a binder, the binder of the magnetic layer comprising a binder that is obtained by a reaction between a hyperbranched polyester and an isocyanate curing agent, and the magnetic layer having an indentation hardness of 392 to 981 MPa (40 to 100 kgf/mm²),

(2) a magnetic recording medium comprising a support and, in order thereabove, a non-magnetic layer comprising a non-magnetic powder dispersed in a binder, and a magnetic layer comprising a ferromagnetic powder dispersed in a binder, the binder of the non-magnetic layer and/or the magnetic layer comprising a binder that is obtained by a reaction between a hyperbranched polyester and an isocyanate curing agent, and the magnetic layer having an indentation hardness of 392 to 981 MPa (40 to 100 kgf/mm²), and

(3) the magnetic recording medium according to (1) or (2) above, wherein the reaction ratio R (R=hyperbranched polyester/isocyanate curing agent) between the hyperbranched polyester and the isocyanate curing agent contained in the magnetic layer is 0.1 to 3.

### BEST MODE FOR CARRYING OUT THE INVENTION

The magnetic recording medium of the present invention includes a binder that is obtained by a reaction between a hyperbranched polyester and an isocyanate curing agent, and the magnetic layer has an indentation hardness of 392 to 981 MPa (40 to 100 kgf/mm²).

The indentation hardness of the magnetic layer is 392 to 981 MPa (40 to 100 kgf/mm²), preferably 480 to 981 MPa (49 to 100 kgf/mm²), and more preferably 588 to 981 MPa (60 to 100 kgf/mm²).

The indentation hardness (DH) referred to here is defined by ISO14577 and can be measured by a micro indentation hardness tester. For example it can be measured using a micro indentation hardness tester (model ENT-1100a) manufactured by Elionix Co., Ltd., and can be determined using the equation below.
DH=3.7926×10⁻²{Pₘₐₓ/(Hₘₐₓ)²}

In the equation, Pₘₐₓ denotes a maximum load and Hₘₐₓ denotes a maximum displacement of an indenter.

1. Hyperbranched Polyester

The hyperbranched polyester referred to here is a multi-branched polyester having a dendritic structure. In the present invention, the ‘hyperbranched polyester’ is therefore also called a ‘multi-branched polyester’. It is described in, for example, a publication such as ‘Dendorima no Kagaku to Kinou’ (Science and Function of Dendrimers) (2000.7.20, published by ICP, p. 86). It is synthesized by self-condensation of a compound having at least three of two types of substituents per molecule, the compound growing while repeatedly branching during polymerization. In the case of a hyperbranched polyester, the substituents are a combination of an OH group and a COOH group, and the OH group may be acetylated or trimethylsilylated. A COOH group that has been converted into an acid chloride or has been trimethylsilylated may also be used.

Specific examples of aromatic type monomer compounds include 3,5-dihydroxybenzoic acid, 5-hydroxyisophthalic acid, derivatives thereof, and derivatives thereof with a modified substituent such as, for example, one having a chain length increased by subjecting a hydroxyl group to an addition reaction with ethylene oxide or propylene oxide, one obtained by subjecting a hydroxyl group to acetylation or trimethylsilylation, and one obtained by converting a carboxyl group to an acid chloride.

Specific examples of aliphatic type monomer compounds include dimethylolpropionic acid, dimethylolbutanoic acid, and derivatives thereof. Examples of the derivatives include one having the chain length increased by the addition of ε-caprolactone.

Examples of the monomer compound are illustrated below.

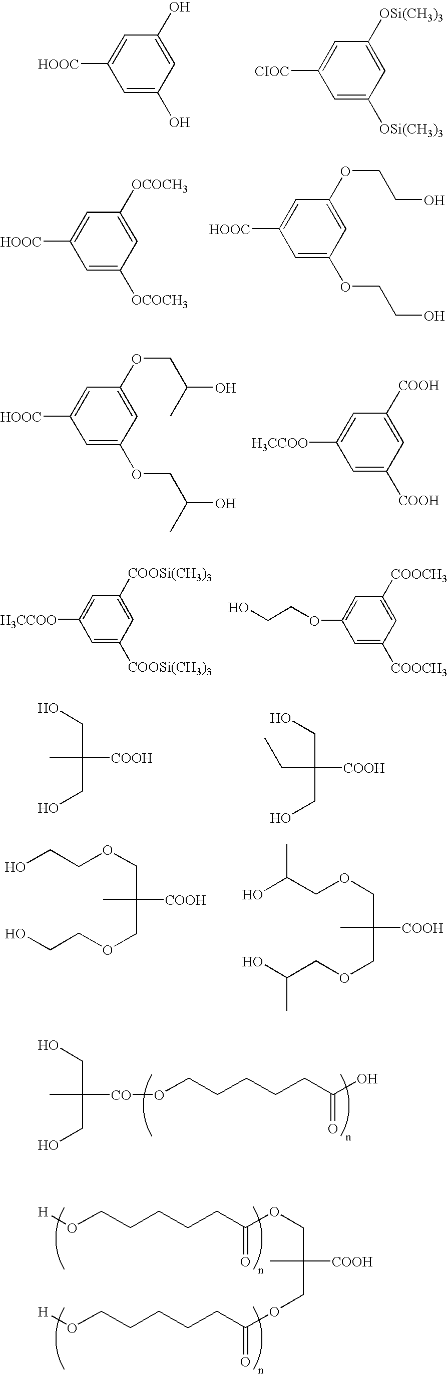

The hyperbranched polyester can be obtained by polymerization of one type of monomer, but it may be obtained by polymerization of a combination of a plurality of monomers or with a small amount of a polyhydric alcohol as a core compound. It is preferable to use a tri- or tetra-hydric alcohol in combination.

Examples of the core compound include glycerol, trimethylolpropane, pentaerythritol, dipentaerythritol, and ethylene oxide adducts and propylene oxide adducts thereof. The degree of branching, the molecular weight, etc. of the hyperbranched polyester can be controlled by the core compound.

Examples of the core compound are illustrated below.

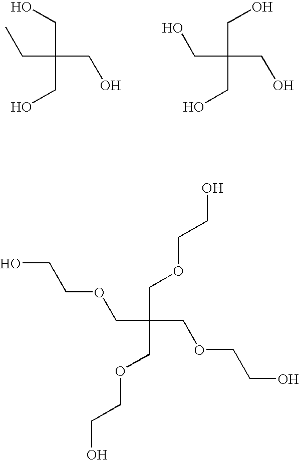

The hyperbranched polyester used in the present invention is preferably a multi-branched polyester obtained from an aliphatic monomer compound, and more preferably a multi-branched polyester that is synthesized by condensation of an AB₂ type molecule. Here, A and B are functional groups, and denote a hydroxyl group or a group derived therefrom, or a carboxyl group or a group derived therefrom. As the AB₂ type molecule, it is particularly preferable that A is a carboxyl group or a group derived therefrom and B is a hydroxyl group or a group derived therefrom. Other than a multi-branched polyester obtained by self-condensation of the AB₂ type molecule, a multi-branched polyester obtained by co-condensation of 1 mol of the AB₂ type molecule and 0.01 to 0.10 mol (preferably, 0.02 to 0.05 mol) of a tri- or tetra-hydric alcohol or a derivative thereof as a nuclear compound may also be used preferably. Furthermore, a multi-branched polyester obtained by self-condensation of dimethylolpropionic acid, dimethylolbutanoic acid, or a derivative thereof, or a multi-branched polyester obtained by co-condensation of 1 mol of the above dimethylolcarboxylic acids and 0.02 to 0.05 mol of pentaerythritol, trimethylolpropane, or a derivative thereof may be suitably used in the present invention.

With regard to a synthetic method therefor, various methods described in the publication cited above, etc. may be used, and there are no particular restrictions. The method may employ polycondensation involving heating and melting or polycondensation in solution using a condensing agent, etc.

The molecular weight of the hyperbranched polyester used in the present invention is preferably 500 to 20,000 as a number-average molecular weight, and more preferably 800 to 10,000.

The degree of branching of the hyperbranched polyester is preferably 0.3 to 0.9, and more preferably 0.4 to 0.8. The degree of branching referred to here is defined in accordance with the Frechet equation and corresponds to the proportion of the total of the numbers of terminal and branched units relative to the total number of units (ref. p. 80 and p. 81 of the above-mentioned publication ‘Science and Function of Dendrimers’).

The terminal group is preferably an OH group. A COOH group may partially remain.

The OH value is preferably 0.1 meq/g to 50 meq/g, and more preferably 1 to 15 meq/g.

When the hyperbranched polyester is added to a magnetic layer, it is preferable to add 0.1 to 15 parts by weight thereof relative to 100 parts by weight of a ferromagnetic powder, and more preferably 1 to 10 parts by weight.

The hyperbranched polyester may be added to a non-magnetic layer comprising a non-magnetic powder dispersed in a binder. When the hyperbranched polyester is added to the non-magnetic layer, it is preferable to add 0.1 to 15 parts by weight thereof, and more preferably 1 to 10 parts by weight, relative to 100 parts by weight of the non-magnetic powder.

2. Isocyanate Curing Agent

The present invention employs an isocyanate curing agent. The isocyanate curing agent referred to here means a compound having at least two isocyanate groups per molecule. The isocyanate curing agents are divided roughly into diisocyanate compounds having two isocyanate groups per molecule and polyisocyanate compounds having three or more isocyanate groups per molecule.

Examples of the diisocyanate compound include aromatic diisocyanates such as MDI (diphenylmethane diisocyanate), 2,4-TDI (tolylene diisocyanate), 2,6-TDI, 1,5-NDI (naphthalene diisocyanate), TODI (tolidine diisocyanate), ρ-phenylene diisocyanate, and XDI (xylylene diisocyanate), and aliphatic and alicyclic diisocyanates such as trans-cyclohexane-1,4-diisocyanate, HDI (hexamethylene diisocyanate), IPDI (isophorone diisocyanate), H₆XDI (hydrogenated xylylene diisocyanate), and H₁₂MDI (hydrogenated diphenylmethane diisocyanate).

It is preferable for the polyisocyanate compound to be a tri- or higher-functional polyisocyanate.

Specific examples thereof include adduct type polyisocyanate compounds such as a compound obtained by adding 3 mol of TDI (tolylene diisocyanate) to 1 mol of trimethylolpropane (TMP), a compound obtained by adding 3 mol of HDI (hexamethylene diisocyanate) to 1 mole of TMP, a compound obtained by adding 3 mol of IPDI (isophorone diisocyanate) to 1 mole of TMP, and a compound obtained by adding 3 mol of XDI (xylylene diisocyanate) to 1 mole of TMP; TDI condensation isocyanurate type trimer, TDI condensation isocyanurate type pentamer, TDI condensation isocyanurate type heptamer, and mixtures thereof; an HDI isocyanurate type condensate, an IPDI isocyanurate type condensate; and crude MDI.

Among these, the compound obtained by adding 3 mol of TDI to 1 mol of TMP, TDI isocyanurate type trimer, etc. are preferable.

The reaction ratio R (the weight ratio R=hyperbranched polyester/isocyanate curing agent) of the hyperbranched polyester and the isocyanate curing agent contained in the magnetic layer is preferably 0.1 to 3, more preferably 0.5 to 3, and most preferably 1 to 2. It is preferable if the ratio R is confined to the above-mentioned range since imprinting can be reduced and high durability can be achieved.

3. Binder

The binders used for both the magnetic layer and the non-magnetic layer are now explained.

For both the magnetic layer and the non-magnetic layer, a binder described in JP-A-10-222838 may be used as the binder.

A vinyl chloride binder may be a copolymer of vinyl chloride with an acrylic or methacrylic monomer such as an alkyl acrylate or an alkyl methacrylate, an allyl ether such as an allyl alkyl ether, a fatty acid vinyl ester such as vinyl acetate or vinyl propionate, a vinyl monomer such as styrene, ethylene, or butadiene, a monomer having a functional group such as a hydroxyl group or an epoxy group, or a monomer having a polar group described below.

As a polyurethane-based binder, polyester urethane, polyether urethane, polycarbonate urethane, polyether ester urethane, acrylic polyurethane, etc. may be used.

The glass transition temperature (Tg) of the polyurethane is preferably −50° C. to +200° C., and more preferably +30° C. to +150° C. If the Tg is in this range, the durability is good. Moreover, since the calender moldability is good, the smoothness and the electromagnetic conversion characteristics are also excellent.

Although it is not particularly limited, because of high affinity with the compounds used in the present invention, it is preferable to use the polyurethane-based binder.

The binder preferably has incorporated therein 1×10⁻⁵ eq/g to 2×10⁻⁴ eq/g of a polar group such as —COOM, —SO₃M, —SO₄M, —PO(OM)₂, —OPO(OM)₂, an amino group, or a quaternary ammonium salt group. When the amount of polar group incorporated is in the above-mentioned range, the dispersibility is good.

In addition, it is preferable to incorporate, as a curing functional group, an OH group, which reacts with an isocyanate curing agent.

It is also preferable to incorporate an epoxy group, which has an affinity for the OH group of the compound used in the present invention or might be bonded to the OH group.

It is preferable to add as a curing agent a polyisocyanate compound or an epoxy compound, and particularly preferably a polyisocyanate compound. A known polyisocyanate compound may be used.

The amount of binder, including the curing agent, in the magnetic layer is preferably 5 to 25 parts by weight relative to 100 parts by weight of the ferromagnetic powder. The amount of binder in the non-magnetic layer is preferably 10 to 30 parts by weight relative to 100 parts by weight of the non-magnetic powder.

4. Magnetic Substance

The magnetic recording medium of the present invention may employ as a magnetic substance an acicular ferromagnetic powder or a tabular magnetic powder described below.

Ferromagnetic Iron Oxide or Ferromagnetic Metal Powder

One form of the ferromagnetic powder used in the magnetic recording medium of the present invention is acicular, and examples thereof include a cobalt-containing ferromagnetic iron oxide or a ferromagnetic alloy powder.

The specific surface area measured by the BET method (hereinafter, SBET means a specific surface area measured by the BET method) is preferably 40 to 80m²/g, and more preferably 50 to 70m²/g.

The length of the major axis is preferably 20 to 200 nm, and more preferably 25 to 60 nm.

The length of the major axis is determined by the combined use of a method in which a transmission electron microscope photograph is taken and the length of the minor axis and the length of the major axis of the ferromagnetic metal powder are measured directly therefrom, and a method in which a transmission electron microscope photograph is traced by an IBASSI image analyzer (manufactured by Carl Zeiss Inc.) and read off.

The crystallite size is preferably 5 to 25 nm, more preferably 8 to 20 nm, and particularly preferably 10 to 15 nm.

The crystallite size is an average value obtained by the Scherrer method from a half-value width of a diffraction peak obtained using an X-ray diffractometer (RINT2000 series, manufactured by Rigaku Corporation) with a CuKα1 radiation source, a tube voltage of 50 kV, and a tube current of 300 mA.

Examples of the ferromagnetic powder include yttrium-containing Fe, Fe—Co, Fe—Ni, and Co—Ni—Fe. The yttrium content in the ferromagnetic powder is preferably 0.5 to 20 atom % as the yttrium atom/Fe atom ratio Y/Fe, and more preferably 5 to 10 atom %. It is preferable if the yttrium content is in such a range since the ferromagnetic powder has a high as value. Since the iron content also becomes appropriate, it is possible to obtain good magnetic properties and electromagnetic conversion characteristics.

Furthermore, it is also possible for aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth, etc. to be present at 20 atom % or less relative to 100 atom % of iron. It is also possible for the ferromagnetic metal powder to contain a small amount of water, a hydroxide, or an oxide.

The form of the ferromagnetic metal powder may be any of acicular, granular, rice-grain shaped, and tabular as long as the above-mentioned requirements for the particle size are satisfied, but it is particularly preferable to use an acicular ferromagnetic metal powder. In the case of the acicular ferromagnetic metal powder, the acicular ratio is preferably 4 to 12, and more preferably 5 to 12.

The coercive force (Hc) of the ferromagnetic metal powder is preferably 159 to 239 kA/m (2,000 to 3,000 Oe), and more preferably 167 to 231 kA/m (2,100 to 2,900 Oe). The saturation magnetic flux density is preferably 100 to 300 mT (1,000 to 3,000 G), and more preferably 160 to 280 mT (1,600 to 2,800 G). The saturation magnetization (as) is preferably 100 to 170 A m²/kg (emu/g), and more preferably 100 to 160 A m²/kg (emu/g).

The SFD (switching field distribution) of the magnetic substance itself is preferably low, and 0.8 or less is preferred. When the SFD is 0.8 or less, the electromagnetic conversion characteristics become good, the output becomes high, the magnetization reversal becomes sharp with a small peak shift, and it is suitable for high-recording-density digital magnetic recording. In order to narrow the Hc distribution, there is a technique of improving the particle size distribution of goethite, a technique of using monodispersed α-Fe₂O₃, and a technique of preventing sintering between particles, etc. in the ferromagnetic metal powder.

One example of a process for producing the ferromagnetic powder of the present invention, into which cobalt or yttrium has been introduced, is illustrated below.

For example, an iron oxyhydroxide obtained by blowing an oxidizing gas into an aqueous suspension in which a ferrous salt and an alkali have been mixed can be used as a starting material. This iron oxyhydroxide is preferably of the α-FeOOH type, and with regard to a production process therefor, there is a first production process in which a ferrous salt is neutralized with an alkali hydroxide to form an aqueous suspension of Fe(OH)₂, and an oxidizing gas is blown into this suspension to give acicular α-FeOOH. There is also a second production process in which a ferrous salt is neutralized with an alkali carbonate to form an aqueous suspension of FeCO₃, and an oxidizing gas is blown into this suspension to give spindle-shaped α-FeOOH. Such an iron oxyhydroxide is preferably obtained by reacting an aqueous solution of a ferrous salt with an aqueous solution of an alkali to give an aqueous solution containing ferrous hydroxide, and then oxidizing this with air, etc. In this case, the aqueous solution of the ferrous salt may contain an Ni salt, a salt of an alkaline earth element such as Ca, Ba, or Sr, a Cr salt, a Zn salt, etc., and by selecting these salts appropriately the particle shape (axial ratio), etc. can be adjusted.

As the ferrous salt, ferrous chloride, ferrous sulfate, etc. are preferable. As the alkali, sodium hydroxide, aqueous ammonia, ammonium carbonate, sodium carbonate, etc. are preferable. With regard to salts that can be present at the same time, chlorides such as nickel chloride, calcium chloride, barium chloride, strontium chloride, chromium chloride, and zinc chloride are preferable.

In a case where cobalt is subsequently introduced into the iron, before introducing yttrium, an aqueous solution of a cobalt compound such as cobalt sulfate or cobalt chloride is mixed and stirred with a slurry of the above-mentioned iron oxyhydroxide. After the slurry of iron oxyhydroxide containing cobalt is prepared, an aqueous solution containing a yttrium compound is added to this slurry, and they are stirred and mixed.

Neodymium, samarium, praseodymium, lanthanum, gadolinium, etc. can be introduced into the ferromagnetic powder of the present invention as well as yttrium. They can be introduced using a chloride such as yttrium chloride, neodymium chloride, samarium chloride, praseodymium chloride, or lanthanum chloride or a nitrate salt such as neodymium nitrate or gadolinium nitrate, and they can be used in a combination of two or more types.

Ferromagnetic Hexagonal Ferrite Powder

Another form of the ferromagnetic powder used in the magnetic recording medium of the present invention is a tabular form, and a ferromagnetic hexagonal ferrite powder is preferably used.

Examples of the hexagonal ferrite include substitution products of barium ferrite, strontium ferrite, lead ferrite, and calcium ferrite, and Co substitution products. More specifically, magnetoplumbite type barium ferrite and strontium ferrite, magnetoplumbite type ferrite with a particle surface coated with a spinel, magnetoplumbite type barium ferrite and strontium ferrite partially containing a spinel phase, etc., can be cited. In addition to the designated atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr may be included. In general, those to which Co—Ti, Co—Ti—Zr, Co—Ti—Zn, Ni—Ti—Zn, Nb—Zn—Co, Sb—Zn—Co, Nb—Zn, etc. have been added can be used. Characteristic impurities may be included depending on the starting material and the production process.

The particle size is preferably 10 to 50 nm as a hexagonal plate size, and more preferably 20 to 40 nm. When a magnetoresistive head is used for playback, the plate size is preferably equal to or less than 40 nm so as to reduce noise. It is preferable if the plate size is in such a range, since stable magnetization can be expected due to the absence of thermal fluctuations, and since noise is reduced it is suitable for high density magnetic recording.

The tabular ratio (plate size/plate thickness) is preferably 1 to 15, and more preferably 2 to 7. It is preferable if the tabular ratio is in such a range since adequate orientation can be obtained, and noise due to inter-particle stacking decreases. The SBET of a powder having a particle size within this range is usually 10 to 200 m²/g. The specific surface area substantially coincides with the value obtained by calculation using the plate size and the plate thickness. The crystallite size is preferably 5 to 45 nm, and more preferably 10 to 35 nm. The plate size and the plate thickness distributions are preferably as narrow as possible. Although it is difficult, the distribution can be expressed using a numerical value by randomly measuring 500 particles on a TEM photograph of the particles.

The distribution is not a regular distribution in many cases, but the standard deviation calculated with respect to the average size is σ/average size=0.1 to 2.0. In order to narrow the particle size distribution, the reaction system used for forming the particles is made as homogeneous as possible, and the particles so formed are subjected to a distribution-improving treatment. For example, a method of selectively dissolving ultrafine particles in an acid solution is also known.

The coercive force (Hc) measured for the magnetic substance can be adjusted so as to be on the order of 39.8 to 398 kA/m (500 to 5,000 Oe). A higher Hc is advantageous for high-density recording, but it is restricted by the capacity of the recording head. It is usually on the order of 63.7 to 318 kA/m (800 to 4,000 Oe), but is preferably at least 119 kA/m (1,500 Oe) and at most 279 kA/m (3,500 Oe). When the saturation magnetization of the head exceeds 1.4 T, it is preferably 159 kA/m (2,000 Oe) or higher. The Hc can be controlled by the particle size (plate size, plate thickness), the type and amount of element included, the element replacement sites, the conditions used for the particle formation reaction, etc. The saturation magnetization (σs) is 40 to 80 A m²/kg (emu/g). A higher σs is preferable, but there is a tendency for it to become lower when the particles become finer. In order to improve the σs, making a composite of magnetoplumbite ferrite with spinel ferrite, selecting the types of element included and their amount, etc. are well known. It is also possible to use a W type hexagonal ferrite.

When dispersing the magnetic substance, the surface of the magnetic substance can be treated with a material that is compatible with a dispersing medium and the polymer. With regard to a surface-treatment agent, an inorganic or organic compound can be used. Representative examples include oxides and hydroxides of Si, Al, P, etc., and various types of silane coupling agents and various kinds of titanium coupling agents. The amount thereof is preferably 0.1% to 10% based on the magnetic substance. The pH of the magnetic substance is also important for dispersion. It is usually on the order of 4 to 12, and although the optimum value depends on the dispersing medium and the polymer, it is selected from on the order of 6 to 10 from the viewpoints of chemical stability and storage properties of the magnetic recording medium. The moisture contained in the magnetic substance also influences the dispersion. Although the optimum value depends on the dispersing medium and the polymer, it is usually selected from 0.01% to 2.0%.

With regard to a production method for the ferromagnetic hexagonal ferrite powder, there are:

glass crystallization method (1) in which barium oxide, iron oxide, a metal oxide that replaces iron, and boron oxide, etc. as glass forming materials are mixed so as to give a desired ferrite composition, then melted and rapidly cooled to give an amorphous substance, subsequently reheated, then washed and ground to give a barium ferrite crystal powder;

hydrothermal reaction method (2) in which a barium ferrite composition metal salt solution is neutralized with an alkali, and after a by-product is removed, it is heated in a liquid phase at 100° C. or higher, then washed, dried and ground to give a barium ferrite crystal powder; and

co-precipitation method (3) in which a barium ferrite composition metal salt solution is neutralized with an alkali, and after a by-product is removed, it is dried and treated at 1100° C. or less, and ground to give a barium ferrite crystal powder, etc., but a hexagonal ferrite used in the present invention may be produced by any method.

5. Non-Magnetic Powder

The magnetic recording medium of the present invention may have a non-magnetic layer comprising a binder and a non-magnetic powder between a non-magnetic support and the magnetic layer.

The non-magnetic powder that can be used in the non-magnetic layer may be an inorganic substance or an organic substance. It is also possible to use carbon black, etc. Examples of the inorganic substance include a metal, a metal oxide, a metal carbonate, a metal sulfate, a metal nitride, a metal carbide, and a metal sulfide. Specific examples thereof include a titanium oxide such as titanium dioxide, cerium oxide, tin oxide, tungsten oxide, ZnO, ZrO₂, SiO₂, Cr₂O₃, α-alumina having an α-component proportion of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, and they can be used singly or in a combination of two or more types. α-Iron oxide or a titanium oxide is preferable.

The form of the non-magnetic powder may be any one of acicular, spherical, polyhedral, and tabular. The crystallite size of the non-magnetic powder is preferably 0.004 to 1 βm, and more preferably 0.04 to 0.1 βm. It is preferable if it is in such a range, since good dispersibility and a smooth surface can be obtained.

The average particle size of these non-magnetic powders is preferably 0.005 to 2 μm, and more preferably 0.01 to 0.2 μm. It is also possible to combine non-magnetic powders having different average particle sizes as necessary, or widen the particle size distribution of a single non-magnetic powder, thus producing the same effect. It is preferable if it is in such a range, since good dispersibility and a smooth surface can be obtained.

The S_{BET} of the non-magnetic powder is preferably 1 to 100 m²/g, more preferably 5 to 70 m²/g, and yet more preferably 10 to 65 m²/g. It is preferable if the specific surface area is in the above range, since a suitable surface roughness can be obtained, and dispersion can be carried out using a desired amount of binder.

The oil absorption measured using dibutyl phthalate (DBP) (DBP oil absorption) is preferably 5 to 100 mL/100 g, more preferably 10 to 80 mL/100 g, and yet more preferably 20 to 60 mL/100 g.

The specific gravity is preferably 1 to 12, and more preferably 3 to 6.

The tap density is preferably 0.05 to 2 g/mL, and more preferably 0.2 to 1.5 g/mL. It is preferable if the tap density is in the range of 0.05 to 2 g/mL, since there is little scattering of particles, the operation is easy, and it is possible to prevent the particles from sticking to equipment.

The pH of the non-magnetic powder is preferably 2 to 11, and particularly preferably 6 to 9. It is preferable if the pH is 2 or greater, since the appropriate coefficient of friction under high temperature and high humidity can be obtained. It is preferable if the pH is 11 or smaller, since the amount of free fatty acid is sufficient, and the appropriate coefficient of friction can be obtained.

The water content of the non-magnetic powder is preferably 0.1 to 5 wt %, more preferably 0.2 to 3 wt %, and yet more.preferably 0.3 to 1.5 wt %. It is preferable if the water content is in the range of 0.1 to 5 wt %, since dispersion is good, and the viscosity of a dispersed coating solution becomes stable.

The ignition loss is preferably 20 wt % or less, and a small ignition loss is preferable.

When the non-magnetic powder is an inorganic powder, the Mohs hardness thereof is preferably in the range of 4 to 10. It is preferable if the Mohs hardness is 4 or more, since sufficient durability can be obtained.

The amount of stearic acid absorbed by the non-magnetic powder is preferably 1 to 20 μmol/m², and more preferably 2 to 15 μmol/m².

The heat of wetting of the non-magnetic powder in water at 25° C. is preferably in the range of 20 to 60 μJ/cm² (200 to 600 erg/cm²). It is possible to use a solvent that gives a heat of wetting in this range. The number of water molecules on the surface at 100° C. to 400° C. is suitably 1 to 10/100 Å. The pH at the isoelectric point in water is preferably between 3 and 9.

The surface of the non-magnetic powder is preferably subjected to a surface treatment with Al₂O₃, SiO₂, TiO₂, ZrO₂, SnO₂, Sb₂O₃, or ZnO. In terms of dispersibility in particular, Al₂O₃, SiO₂, TiO₂, and ZrO₂ are preferable, and Al₂O₃, SiO₂, and ZrO₂ are more preferable. They may be used in combination or singly. Depending on the intended purpose, a surface-treated layer may be obtained by co-precipitation, or a method can be employed in which the surface is firstly treated with alumina and the surface thereof is then treated with silica, or vice versa. The surface-treated layer may be formed as a porous layer depending on the intended purpose, but it is generally preferable for it to be uniform and dense.

Specific examples of the non-magnetic powder used in the non-magnetic layer of the present invention include Nanotite (manufactured by Showa Denko K.K.), HIT-100 and ZA-G1 (manufactured by Sumitomo Chemical Co., Ltd.), DPN-250, DPN-250BX, DPN-245, DPN-270BX, DPB-550BX, and DPN-550RX (manufactured by Toda Kogyo Corp.), titanium oxide TTO-51B, TTO-55A, TTO-55B, TTO-55C, TTO-55S, TTO-55D, SN-100, and MJ-7, and α-iron oxide E270, E271, and E300 (manufactured by Ishihara Sangyo Kaisha Ltd.), STT-4D, STT-30D, STT-30, and STT-65C (manufactured by Titan Kogyo Kabushiki Kaisha), MT-100S, MT-100T, MT-150W, MT-500B, MT-600B, MT-100F, and MT-500HD (manufactured by Tayca Corporation), FINEX-25, BF-1, BF-10, BF-20, and ST-M (manufactured by Sakai Chemical Industry Co., Ltd.), DEFIC-Y and DEFIC-R (manufactured by Dowa Mining Co., Ltd.), AS2BM and TiO₂P25 (manufactured by Nippon Aerosil Co., Ltd.), 100A and 500A (manufactured by Ube Industries, Ltd.), Y-LOP (manufactured by Titan Kogyo Kabushiki Kaisha), and calcined products thereof. Particularly preferred non-magnetic powders are titanium dioxide and α-iron oxide.

By mixing carbon black with the non-magnetic powder, the surface electrical resistance (Rs) of the non-magnetic layer can be reduced, the light transmittance can be decreased, and a desired micro Vickers hardness can be obtained.

The micro Vickers hardness of the non-magnetic layer is usually 25 to 60 kg/mm², and is preferably 30 to 50 kg/mm2 in order to adjust the head contact. The micro Vickers hardness can be measured using a thin film hardness meter (HMA-400 manufactured by NEC Corporation) with, as an indenter tip, a triangular pyramidal diamond needle having a tip angle of 80° and a tip radius of 0.1 μm.

The light transmittance is generally standardized such that the absorption of infrared rays having a wavelength of on the order of 900 nm is 3% or less and, in the case of, for example, VHS magnetic tapes, 0.8% or less. Because of this, furnace black for rubber, thermal black for rubber, carbon black for coloring, acetylene black, etc. can be used.

The specific surface area of the carbon black used in the non-magnetic layer of the present invention is preferably 100 to 500 m²/g, and more preferably 150 to 400 m²/g, and the DBP oil absorption thereof is preferably 20 to 400 mL/100 g, and more preferably 30 to 200 mL/100 g. The average particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black used in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, and MA-600 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbian Carbon Co.), and Ketjen Black EC (manufactured by Akzo).

The carbon black may be surface treated using a dispersant or grafted with a resin, or part of the surface thereof may be converted into graphite. Prior to adding carbon black to a coating solution, the carbon black may be predispersed with a binder. The carbon black can be used in a range that does not exceed 50 wt % of the above-mentioned inorganic powder and in a range that does not exceed 40 wt % of the total weight of the non-magnetic layer. These types of carbon black may be used singly or in combination. The carbon black that can be used in the non-magnetic layer of the present invention can be selected by referring to, for example, the ‘Kabon Burakku Binran’ (Carbon Black Handbook) (edited by the Carbon Black Association of Japan).

It is also possible to add an organic powder to the non-magnetic layer, depending on the intended purpose. Examples thereof include an acrylic styrene resin powder, a benzoguanamine resin powder, a melamine resin powder, and a phthalocyanine pigment, but a polyolefin resin powder, a polyester resin powder, a polyamide resin powder, a polyimide resin powder, and a polyfluoroethylene resin can also be used.

6. Other Additives

In the magnetic recording medium of the present invention, additives for imparting a dispersion effect, lubrication effect, antistatic effect, plasticizing effect, etc. may be included in the magnetic layer or the non-magnetic layer.

Examples of these additives are as follows.

Molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, a polyphenyl ether; aromatic ring-containing organic phosphonic acids such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, tolylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid, and alkali metal salts thereof; alkylphosphonic acids such as octylphosphonic acid, 2-ethylhexylphosphonic acid, isooctylphosphonic acid, (iso)nonylphosphonic acid, (iso)decylphosphonic acid, (iso)undecylphosphonic acid, (iso)dodecylphosphonic acid, (iso)hexadecylphosphonic acid, (iso)octadecylphosphonic acid, and (iso)eicosylphosphonic acid, and alkali metal salts thereof.

Aromatic phosphates such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, tolyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates such as octyl phosphate, 2-ethylhexyl phosphate, isooctyl phosphate, (iso)nonyl phosphate, (iso)decyl phosphate, (iso)undecyl phosphate, (iso)dodecyl phosphate, (iso)hexadecyl phosphate, (iso)octadecyl phosphate, and (iso)eicosyl phosphate, and alkali metal salts thereof.

Alkyl sulfonates and alkali metal salts thereof; fluorine-containing alkyl sulfates and alkali metal salts thereof; monobasic fatty acids that have 10 to 24 carbons, may contain an unsaturated bond, and may be branched, such as lauric acid, myristic acid, palmitic acid, stearic acid, behenic acid, oleic acid, linoleic acid, lirolenic acid, elaidic acid, and erucic acid, and metal salts thereof; mono-fatty acid esters, di-fatty acid esters, and poly-fatty acid esters such as butyl stearate, octyl stearate, amyl stearate, isooctyl stearate, octyl myristate, butyl laurate, butoxyethyl stearate, anhydrosorbitan monostearate, anhydrosorbitan distearate, and anhydrosorbitan tristearate that are formed from a monobasic fatty acid that has 10 to 24 carbons, may contain an unsaturated bond, and may be branched, and any one of a mono- to hexa-hydric alcohol that has 2 to 22 carbons, may contain an unsaturated bond, and may be branched, an alkoxy alcohol that has 12 to 22 carbons, may have an unsaturated bond, and may be branched, and a mono alkyl ether of an alkylene oxide polymer; fatty acid amides having 2 to 22 carbons; aliphatic amines having 8 to 22 carbons; etc. Other than the above-mentioned hydrocarbon groups, those having an alkyl, aryl, or aralkyl group that is substituted with a group other than a hydrocarbon group, such as a nitro group, F, Cl, Br, or a halogen-containing hydrocarbon such as CF₃, CCl₃, or CBr₃ can also be used.

Furthermore, there are a nonionic surfactant such as an alkylene oxide type, a glycerol type, a glycidol type, or an alkylphenol-ethylene oxide adduct; a cationic surfactant such as a cyclic amine, an ester amide, a quaternary ammonium salt, a hydantoin derivative, a heterocyclic compound, a phosphonium salt, or a sulfonium salt; an anionic surfactant containing an acidic group such as a carboxylic acid, a sulfonic acid or a sulfate ester group; and an amphoteric surfactant such as an amino acid, an aminosulfonic acid, a sulfate ester or a phosphate ester of an amino alcohol, or an alkylbetaine. Details of these surfactants are described in ‘Kaimenkasseizai Binran’ (Surfactant Handbook) (published by Sangyo Tosho Publishing). These lubricants, antistatic agents, etc. need not always be pure and may contain, in addition to the main component, an impurity such as an isomer, an unreacted material, a by-product, a decomposition product, or an oxide. However, the impurity content is preferably 30 wt % or less, and more preferably 10 wt % or less.

Specific examples of these additives include NAA-102, hardened castor oil fatty acid, NAA-42, Cation SA, Nymeen L-201, Nonion E-208, Anon BF, and Anon LG, (produced by Nippon Oil & Fats Co., Ltd.); FAL-205, and FAL-123 (produced by Takemoto Oil & Fat Co., Ltd); Enujelv OL (produced by New Japan Chemical Co., Ltd.); TA-3 (produced by Shin-Etsu Chemical Industry Co., Ltd.); Armide P (produced by Lion Armour); Duomin TDO (produced by Lion Corporation); BA-41G (produced by The Nisshin Oil Mills, Ltd.); and Profan 2012E, Newpol PE 61, and lonet MS-400 (produced by Sanyo Chemical Industries, Ltd.).

The type and the amount of the dispersant, lubricant, and surfactant used in the present invention can be changed as necessary in the non-magnetic layer and the magnetic layer. For example, although not limited to only the examples illustrated here, the dispersant has the property of adsorbing or bonding via its polar group, and it is surmised that the dispersant adsorbs or bonds, via the polar group, to mainly the surface of the ferromagnetic powder in the magnetic layer and mainly the surface of the non-magnetic powder in the non-magnetic layer, and once adsorbed it is hard to desorb an organophosphorus compound from the surface of a metal, a metal compound, etc. Therefore, since in the present invention the surface of the ferromagnetic powder or the surface of the non-magnetic powder are in a state in which they are covered with an alkyl group, an aromatic group, etc., the affinity of the ferromagnetic powder or the non-magnetic powder toward the binder resin component increases and, furthermore, the dispersion stability of the ferromagnetic powder or the non-magnetic powder is also improved. With regard to the lubricant, since it is present in a free state, its exudation to the surface is controlled by using fatty acids having different melting points for the non-magnetic layer and the magnetic layer or by using esters having different boiling points or polarity. The coating stability can be improved by regulating the amount of surfactant added, and the lubrication effect can be improved by increasing the amount of lubricant added to the non-magnetic layer.

All or a part of the additives used in the present invention may be added to a magnetic coating solution or a non-magnetic coating solution at any stage of its preparation. For example, the additives may be blended with a ferromagnetic powder prior to a kneading step, they may be added in a step of kneading a ferromagnetic powder, a binder, and a solvent, they may be added in a dispersing step, they may be added after dispersion, or they may be added immediately prior to coating.

An organic solvent used for the magnetic layer or the non-magnetic layer of the present invention can be a known organic solvent. As the organic solvent, a ketone such as acetone, methyl ethyl ketone, methyl isobutyl ketone, diisobutyl ketone, cyclohexanone, or isophorone, an alcohol such as methanol, ethanol, propanol, butanol, isobutyl alcohol, isopropyl alcohol, or methylcyclohexanol, an ester such as methyl acetate, butyl acetate, isobutyl acetate, isopropyl acetate, ethyl lactate, or glycol acetate, a glycol ether such as glycol dimethyl ether, glycol monoethyl ether, or dioxane, an aromatic hydrocarbon such as benzene, toluene, xylene, or cresol, a chlorohydrocarbon such as methylene chloride, ethylene chloride, carbon tetrachloride, chloroform, ethylene chlorohydrin, chlorobenzene, or dichlorobenzene, N,N-dimethylformamide, hexane, tetrahydrofuran, etc. can be used at any ratio.

These organic solvents do not always need to be 100% pure, and may contain an impurity such as an isomer, an unreacted compound, a by-product, a decomposition product, an oxide, or moisture in addition to the main component. The content of these impurities is preferably 30% or less, and more preferably 10% or less. The organic solvent used in the present invention is preferably the same type for both the magnetic layer and the non-magnetic layer. However, the amount added may be varied. The coating stability is improved by using a high surface tension solvent (cyclohexanone, dioxane, etc.) for the non-magnetic layer; more specifically, it is important that the arithmetic mean value of the surface tension of the magnetic layer solvent composition is not less than that for the surface tension of the non-magnetic layer solvent composition. In order to improve the dispersibility, it is preferable for the polarity to be somewhat strong, and the solvent composition preferably contains 50% or more of a solvent having a permittivity of 15 or higher. The solubility parameter is preferably 8 to 11.

7. Support

In the magnetic recording medium of the present invention, the non-magnetic layer or the magnetic layer is formed by coating a non-magnetic support with a coating solution prepared using the above-mentioned materials.

With regard to the non-magnetic support that can be used in the present invention, known biaxially stretched films such as polyethylene naphthalate, polyethylene terephthalate, polyamide, polyimide, polyamideimide, aromatic polyamide, and polybenzoxazole can be used. Polyethylene naphthalate and aromatic polyamide are preferred. These non-magnetic supports can be subjected in advance to a corona discharge treatment, a plasma treatment, a treatment for enhancing adhesion, a thermal treatment, etc.

The non-magnetic support that can be used in the present invention preferably has a surface having excellent smoothness such that its center line average surface roughness is in the range of 0.1 to 20 nm, and preferably 1 to 10 nm, for a cutoff value of 0.25 mm. Furthermore, these non-magnetic supports preferably have not only a small center line average surface roughness but also no coarse projections with a height of 1 μm or greater.

The arithmetic mean roughness (Ra) of the treated support is preferably 0.1 μm or less [JIS B0660-1998, ISO 4287-1997] since a magnetic recording medium obtained therefrom has a low level of noise.

A preferred thickness of the non-magnetic support of the magnetic recording medium of the present invention is 3 to 80 μm.

8. Backcoat Layer

A backcoat layer (backing layer) may be provided on the side of the non-magnetic support used in the present invention that is not coated with a magnetic coating solution. The backcoat layer is a layer provided by applying, on the side of the non-magnetic support that is not coated with the magnetic coating solution, a backcoat layer-forming coating solution in which particulate components such as an abrasive or an antistatic agent and a binder are dispersed in an organic solvent. As the particulate components, various inorganic pigments or carbon black can be used, and as the binder, resins such as nitrocellulose, a phenoxy resin, or polyurethane can be used singly or as a mixture thereof. An adhesive layer may be provided on the side of the non-magnetic support of the present invention that is coated with the magnetic coating solution or the backcoat layer-forming coating solution.

9. Undercoat Layer

In the magnetic recording medium of the present invention, an undercoat layer can be provided. Providing the undercoat layer enables the adhesion between the support and the magnetic layer or the non-magnetic layer to be improved. A solvent-soluble polyester resin may be used in the undercoat layer. The thickness of the undercoat layer is 0.5 μm or less.

10. Smoothing Layer

The magnetic recording medium of the present invention may be provided with a smoothing layer. The smoothing layer referred to here is a layer for burying projections on the surface of the non-magnetic support; it is provided between the non-magnetic support and the magnetic layer when the magnetic recording medium is provided with the magnetic layer on the non-magnetic support, and it is provided between the non-magnetic support and the non-magnetic layer when the magnetic recording medium is provided with the non-magnetic layer and the magnetic layer in that order on the non-magnetic support.

The smoothing layer can be formed by curing a radiation curable compound by exposure to radiation. The radiation curable compound referred to here is a compound having the property of polymerizing or crosslinking when irradiated with radiation such as ultraviolet rays or an electron beam, thus increasing the molecular weight and carrying out curing.

11. Production Method

A process for producing a magnetic layer coating solution for the magnetic recording medium used in the present invention comprises at least a kneading step, a dispersing step and, optionally, a blending step that is carried out prior to and/or subsequent to the above-mentioned steps. Each of these steps may be composed of two or more separate stages. All materials, including the ferromagnetic powder (the ferromagnetic hexagonal ferrite powder, the ferromagnetic metal powder), the non-magnetic powder, the binder, the carbon black, the abrasive, the antistatic agent, the lubricant, and the solvent used in the present invention may be added in any step from the beginning or during the course of the step. The addition of each material may be divided across two or more steps.

In the process for producing the magnetic recording medium of the present invention, when preparing the magnetic coating solution, which is a coating solution for the magnetic layer, at least one magnetic coating solution is prepared in which a ferromagnetic powder is dispersed in a binder solution containing a binder that is obtained by a reaction between a hyperbranched polyester and an isocyanate curing agent. When preparing this magnetic coating solution, a kneading step is employed in which the ferromagnetic powder and a hyperbranched polyester, as all or part of the binder for the magnetic layer, are kneaded. In the kneading step, it is preferable to use a conventionally known powerful kneading machine such as an open kneader, a continuous kneader, a pressure kneader, or an extruder. When such a kneader is used, all or part of the binder (preferably 30 wt % or more of the entire binder) is preferably kneaded with the ferromagnetic powder. The proportion of the binder added is preferably 10 to 500 parts by weight relative to 100 parts by weight of the ferromagnetic powder. Details of these kneading treatments are described in JP-A-1-106338 and JP-A-1-79274.

A dispersing step is carried out subsequent to the kneading step. A coating solvent is added to the mixture of the ferromagnetic powder and the binder obtained in the kneading step, and the ferromagnetic powder is completely dispersed in the binder solution using a sand mill, etc. In order to disperse the magnetic layer coating solution or a non-magnetic layer coating solution, glass beads may be used. As such glass beads, a dispersing medium having a high specific gravity such as zirconia beads, titania beads, or steel beads is suitably used. An optimal particle size and packing ratio of these dispersing media is used. A known disperser such as a sand mill may be used.

With regard to a method for coating the non-magnetic support with the magnetic coating solution in the present invention, for example, the surface of a moving non-magnetic support is coated with a magnetic layer coating solution so as to give a predetermined coating thickness. A plurality of magnetic layer coating solutions can be applied successively or simultaneously in multilayer coating, and a non-magnetic layer coating solution and a magnetic layer coating solution can also be applied successively or simultaneously in multilayer coating. As coating equipment for applying the above-mentioned magnetic coating solution or the non-magnetic layer coating solution, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used.

With regard to these, for example, ‘Saishin Kotexingu Gijutsu’ (Latest Coating Technology) (May 31, 1983) published by Sogo Gijutsu Center can be referred to. As examples of the coating equipment and the coating method for the magnetic recording medium of the present invention, the following can be proposed.

(1) A lower layer is firstly applied by coating equipment such as gravure, roll, blade, or extrusion coating equipment, which is generally used for coating with a magnetic coating solution, and before the lower layer has dried an upper layer is applied by a pressurized support type extrusion coating device such as one disclosed in JP-B-1-46186, JP-A-60-238179, or JP-A-2-265672 (JP-B denotes a Japanese examined patent application publication).

(2) Upper and lower layers are substantially simultaneously applied by means of one coating head having two slits for a coating solution to pass through, such as one disclosed in JP-A-63-88080, JP-A-2-17971, or JP-A-2-265672.

(3) Upper and lower layers are substantially simultaneously applied by means of an extrusion coating device with a backup roll, such as one disclosed in JP-A-2-174965.

The thickness of the magnetic layer of the magnetic recording medium of the present invention is optimized according to the head saturation magnetization, the head gap, and the bandwidth of the recording signal, and is generally 0.01 to 0.10 μm, preferably 0.02 to 0.10 μm, more preferably 0.03 to 0.10 μm, and yet more preferably 0.03 to 0.08 μm. The magnetic layer can be divided into two or more layers having different magnetic properties, and the configuration of a known multilayer magnetic layer can be employed.

When a non-magnetic layer is provided in the present invention, the thickness thereof is preferably 0.2 to 3.0 μm, more preferably 0.3 to 2.5 82 m, and yet more preferably 0.4 to 2.0 μm. The non-magnetic layer of the magnetic recording medium of the present invention exhibits its effect as long as it is substantially non-magnetic, but even if it contains a small amount of a magnetic substance as an impurity or intentionally, if the effects of the present invention are exhibited, the constitution can be considered to be substantially the same as that of the magnetic recording medium of the present invention. ‘Substantially the same’ referred to here means that the non-magnetic layer has a residual magnetic flux density of 10 mT (100 G) or less or a coercive force of 7.96 kA/m (100 Oe) or less, and preferably has no residual magnetic flux density and no coercive force.

The binder that is obtained by a reaction between a hyperbranched polyester and an isocyanate curing agent may be used as all or part of the binder of the non-magnetic layer. It is preferable to use it as all of the binder of the non-magnetic layer.

In the present invention, it is preferable to provide the non-magnetic layer containing the inorganic powder on the support in order to apply the magnetic layer stably, and to apply the magnetic layer by a wet-on-wet method.

In the case of a magnetic tape, the coated layer of the magnetic layer coating solution is subjected to a magnetic field alignment treatment in which the ferromagnetic powder contained in the coated layer of the magnetic layer coating solution is aligned in the longitudinal direction using a cobalt magnet or a solenoid. In the case of a disk, although sufficient isotropic alignment can sometimes be obtained without using an alignment device, it is preferable to employ a known random alignment device such as, for example, arranging obliquely alternating cobalt magnets or applying an alternating magnetic field with a solenoid. The isotropic alignment referred to here means that, in the case of a ferromagnetic metal powder, in general, in-plane two-dimensional random is preferable, but it can be three-dimensional random by introducing a vertical component. In the case of a ferromagnetic hexagonal ferrite powder, in general, it tends to be in-plane and vertical three-dimensional random, but in-plane two-dimensional random is also possible. By using a known method such as magnets having different poles facing each other so as to make vertical alignment, circumferentially isotropic magnetic properties can be introduced. In particular, when carrying out high density recording, vertical alignment is preferable. Furthermore, circumferential alignment may be employed using spin coating.

It is preferable for the drying position for the coating to be controlled by controlling the drying temperature and blowing rate and the coating speed; it is preferable for the coating speed to be 20 m/min to 1,000 m/min and the temperature of drying air to be 60° C. or higher. An appropriate level of pre-drying may be carried out prior to entering a magnet zone.

After drying is carried out, the coated layer is subjected to a surface smoothing treatment. The surface smoothing treatment employs, for example, super calender rolls, etc. By carrying out the surface smoothing treatment, cavities formed by removal of the solvent during drying are eliminated, thereby increasing the packing ratio of the ferromagnetic powder in the magnetic layer, and a magnetic recording medium having high electromagnetic conversion characteristics can thus be obtained.

With regard to calendering rolls, rolls of a heat-resistant plastic such as epoxy, polyimide, polyamide, or polyamideimide are used. It is also possible to treat with metal rolls.

The magnetic recording medium of the present invention preferably has a surface center line average roughness in the range of 0.1 to 4 nm for a cutoff value of 0.25 mm, and more preferably 1 to 3 nm, which is extremely smooth. As a method therefor, a magnetic layer formed by selecting a specific ferromagnetic powder and binder as described above is subjected to the above-mentioned calendering treatment.

The calender roll temperature is preferably in the range of 60° C. to 100° C,. more preferably in the range of 70° C. to 100° C., and yet more preferably in the range of 80° C. to 100° C. The calender roll pressure is preferably in the range of 100 to 500 kg/cm, more preferably in the range of 200 to 450 kg/cm, and yet more preferably in the range of 300 to 400 kg/cm. The magnetic recording medium thus obtained can be cut to a desired size using a cutter, etc. before use.

The magnetic recording medium of the present invention includes a binder that is obtained by a reaction between a hyperbranched polyester and an isocyanate curing agent, and since the magnetic layer has a high indentation hardness of 392 to 981 MPa (40 to 100 kgf/mm²), even when it is subjected to a thermal treatment in bulk there is little imprint from projections on the back face, thereby enabling the number of dropouts to be suppressed to a low level.

### EXAMPLES

The present invention is explained in detail below by reference to Examples, but these Examples should not be construed as limiting the present invention.

In the explanation below, ‘parts’ means ‘parts by weight’.

### Synthetic Example 1

A reaction vessel equipped with a thermometer, a stirrer, and a partial reflux condenser was charged with 0.5 mol (68 g) of pentaerythritol (molecular weight 136), 2 mol (296 g) of dimethylolbutanoic acid (molecular weight 148), and 0.5 mmol (87 mg) of p-toluenesulfonic acid, and the mixture was heated to 130° C. and then heated over 1 hour to 140° C. while evacuating. Following this, 12 mol (1,776 g) of dimethylolbutanoic acid was added to the reaction mixture, and a reaction was carried out at 140° C. under vacuum for 5 hours while stirring.

The hyperbranched polyester (A) thus obtained had an OH value of 4.1 meq/g, a GPC molecular weight (on a polystyrene basis) of 3,900 as a number-average, and a weight-average molecular weight of 12,000.

### Synthetic Example 2

A reaction vessel equipped with a thermometer, a stirrer, and a partial reflux condenser was charged with 0.5 mol (67 g) of trimethylolpropane (molecular weight 134), 1.5 mol (201 g) of dimethylolpropionic acid (molecular weight 134), and 0.5 mmol (87 mg) of p-toluenesulfonic acid, and the mixture was heated to 120° C. and then heated over 1 hour to 140° C. while evacuating. Following this, 9 mol (1,206 g) of dimethylolpropionic acid was added to the reaction mixture, and a reaction was carried out at 140° C. under vacuum for 5 hours while stirring.

The hyperbranched polyester (B) thus obtained had an OH value of 4.7 meq/g, a GPC molecular weight (on a polystyrene basis) of 2,600 as a number-average, and a weight-average molecular weight of 6,900.

### Synthetic Example 3

A reaction vessel equipped with a thermometer, a stirrer, and a partial reflux condenser was charged with 8 mol (1,184 g) of dimethylolbutanoic acid (molecular weight 148) and 0.5 mmol (87 mg) of p-toluenesulfonic acid, and the mixture was heated to 120° C. and then heated over 1 hour to 140° C. while evacuating, and a reaction was carried out for 5 hours while stirring.

The hyperbranched polyester (C) thus obtained had an OH value of 4.0 meq/g, a GPC molecular weight (on a polystyrene basis) of 1,600 as a number-average, and a weight-average molecular weight of 4,200.

### Example 1

Preparation of magnetic solution for magnetic layer
100 parts of a ferromagnetic alloy powder A (composition: Co 20
atom %, Al 9 atom %, and Y 6 atom % relative to Fe 100 atom %;
Hc 175 kA/m (2,200 Oe); crystallite size 11 nm; S_{BET} 70 m²/g;
major axis length 45 nm; σs 111 A · m²/kg (emu/g)) was
ground in an open kneader for 10 minutes, and then kneaded for
60 minutes with

| | | |
|---|---|---|
| 30% methyl ethyl ketone (MEK)/toluene (=1/1) | 20 | parts |
| solution of the hyperbranched polyester (C) | | |
| 30% cyclohexanone solution of vinyl chloride | 20 | parts, and |
| copolymer MR110 (manufactured by Nippon Zeon | | |
| Corporation) | | |
| 30% MEK/toluene (=1/1) solution of | 20 | parts. |
| polyurethane resin UR8200 (manufactured by | | |
| Toyobo Co., Ltd.) | | |
| Subsequently, | | |
| α-alumina HIT55 (manufactured by Sumitomo | 10 | parts |
| Chemical Co., Ltd.) | | |
| carbon black #50 (manufactured by Asahi Carbon) | 3 | parts, and |
| MEK/toluene (=1/1) | 200 | parts |

were added, and the mixture was dispersed in a sand mill for
120 minutes. To this were added

| | | |
|---|---|---|
| 30% MEK/toluene (=1/1) solution of | 15 | parts |
| polyisocyanate Coronate 3041 (a NCO value of 3/mol, | | |
| a molecular weight of 656.2, manufactured by Nippon | | |
| Polyurethane Industry Co., Ltd.) | | |
| stearic acid | 1 | part |
| myristic acid | 1 | part |
| isohexadecyl stearate | 3 | parts, and |
| MEK | 100 | parts |

and after stirring the mixture for a further 20 minutes, it was
filtered using a filter having an average pore size of 1 μm to give
a magnetic coating solution.
Preparation of non-magnetic coating solution for non-magnetic layer
85 parts of acicular α-iron oxide (major axis length 100 nm; alumina
surface treatment layer; S_{BET} 52 m²/g; pH 9.4)
and 15 parts of Ketjen black EC carbon black (manufactured by Ketjen
Black International Company Ltd.) were ground in an open kneader for
10 minutes, and then kneaded for 60 minutes with

| | | |
|---|---|---|
| 30% cyclohexanone solution of vinyl chloride | 60 | parts |
| copolymer MR110 (manufactured by Nippon Zeon | | |
| Corporation) | | |
| 30% MEK/toluene (=1/1) solution of | 60 | parts, and |
| polyurethane resin UR8200 | | |
| (manufactured by Toyobo Co., Ltd.) | | |
| cyclohexanone | 20 | parts. |
| Subsequently, | | |
| MEK/cyclohexanone (=6/4) | 200 | parts |

was added, and the mixture was dispersed in a sand mill for
120 minutes. To this were added

| | | |
|---|---|---|
| 30% MEK/toluene (=1/1) solution of polyisocyanate | 15 | parts |
| Coronate 3041 (manufactured by Nippon Polyurethane | | |
| Industry Co., Ltd.) | | |
| stearic acid | 1 | part |
| myristic acid | 1 | part |
| isooctyl stearate | 3 | parts, and |
| MEK | 50 | parts |

and after stirring the mixture for a further 20 minutes, it
was filtered using a filter having an average pore size of
1 μm to give a non-magnetic coating solution.

A surface of a 6.0 μm thick polyethylene naphthalate support was subjected to simultaneous multilayer coating with the non-magnetic coating solution so obtained at 1.2 μm and immediately after that with the magnetic coating solution at a dry thickness of 0.1 μm. Before the magnetic coating solution had dried, it was subjected to magnetic field alignment using a 5,000 G Co magnet and a 4,000 G solenoid magnet, and the coating was then subjected to a calender treatment employing a metal roll-metal roll-metal roll-metal roll-metal roll-metal roll-metal roll combination (speed 100 m/min, line pressure 300 kg/cm, temperature 90° C.), then subjected to a thermal treatment at 50° C. for 7 days, and slit to a width of 3.8 mm to give a magnetic tape.

### Example 2

The procedure of Example 1 was repeated except that the hyperbranched polyester was changed to that shown in Table 1, thus giving a magnetic tape of Example 2.

### Example 3

The procedure of Example 1 was repeated except that, for the preparation
of a magnetic layer magnetic solution, the hyperbranched polyester
(A) was added instead of the hyperbranched polyester (C), and for
the preparation of a non-magnetic layer non-magnetic solution,

| | | |
|---|---|---|
| 30% MEK/toluene (=1/1) solution of | 20 | parts |
| the hyperbranched polyester (A) | | |
| 30% cyclohexanone solution of vinyl | 20 | parts, and |
| chloride copolymer MR110 (manufactured by | | |
| Nippon Zeon Corporation) | | |
| 30% MEK/toluene (=1/1) solution of | 20 | parts. |
| polyurethane resin UR8200 | | |
| (manufactured by Toyobo Co., Ltd.) | | |
| were added instead of | | |
| 30% cyclohexanone solution of vinyl | 60 | parts, and |
| chloride copolymer MR110 | | |
| (manufactured by Nippon Zeon Corporation) | | |
| 30% MEK/toluene (=1/1) solution of | 60 | parts, |
| polyurethane resin UR8200 | | |
| (manufactured by Toyobo Co., Ltd.) | | |
| thus giving a magnetic tape of Example 3. | | |

### Comparative Example 1

The procedure of Example 1 was repeated except that the hyperbranched polyester was not added, thus giving a magnetic tape of Comparative Example 1.

Measurement Methods

(1) Magnetic Layer Indentation Hardness

Measurement System

As a measurement system, a micro indentation hardness tester (model ENT-1100a) manufactured by Elionix Co., Ltd. was used. The main specifications of the system were as follows.
Load generation type: electromagnetic force type
Indenter: triangular pyramidal indenter, blade angle 65°, ridge angle 115°, made of diamond
Load range: 19.6 μN to 0.98 N (2 mgf to 100 gf)
Load resolution: 0.2 μN
Displacement measurement method: movement of indenter is detected in terms of capacitance
Displacement range: 20 μm or below
Displacement reading resolution: 0.3 nm
   Measurement Conditions

A 5 mm×5 mm piece was cut out of the magnetic tape and fixed to an aluminum sample holder by adhesive, after the adhesive has dried the sample was allowed to stand in the measurement environment for about 30 minutes for conditioning, and measurement was carried out. The measurement conditions were as follows.
Test load: 58.8 μN (6 mgf)
Number of divisions: 100
Step interval: 100 msec
Load application: the load was increased continuously up to 58.8 μN (6 mgf) over 10 sec., held at 58.8 μN (6 mgf) for 1 sec., and the load was then removed over 10 sec.
Measurement environment: temperature 28±0.1° C.
Number n of measurements: measurement was carried out for 7 positions on the backcoat layer, and the central 5 values from the measurements were used as measurement values.
   (2) Number of Magnetic Layer indentations of 20 nm or greater

An optical surface profiler (The NewView 5000, manufactured by Zygo Corporation) was used, and 5 points were measured in a measurement area of 0.091 mm² using a 20× object lens. The average value thereof was defined as the number of magnetic layer indentations of 20 nm or greater.

(3) Dropouts

Dropouts (DO) were evaluated by winding samples prepared in Examples 1 to 3 and Comparative Example 1 around LTO reels. The DO number was obtained by writing a signal of 130 kfci using a write head having a width of 25 μm and playing back the signal using an MR head having a width of 5 μm.

The hyperbranched polyesters and the isocyanate curing agents used in Examples and Comparative Example and the measurement results are given in Table 1.

TABLE 1

| | | | | Comparative |
|---|---|---|---|---|
| | Example 1 | Example 2 | Example 3 | Example 1 |
| Magnetic layer | | | | |
| Hyperbranched | C | B | A | None |
| polyester | | | | |
| Isocyanate curing | Coronate | Coronate | Coronate | Coronate |
| agent | 3041 | 3041 | 3041 | 3041 |
| Non-magnetic layer | | | | |
| Hyperbranched | None | None | A | None |
| polyester | | | | |
| Isocyanate curing | Coronate | Coronate | Coronate | Coronate |
| agent | 3041 | 3041 | 3041 | 3041 |
| Reaction ratio R | 1.3 | 0.10 | 3.0 | 0 |
| Magnetic layer | 892 (91) | 481 (49) | 725 (74) | 216 (22) |
| indentation hardness | | | | |
| MPa (kgf/mm²) | | | | |
| Magnetic layer 20 nm | 1 | 6 | 3 | 59 |
| or greater indentation | | | | |
| Dropouts number/m | 2 | 10 | 5 | 290 |

As shown in Table 1, for Examples 1 to 3, all of the conditions were within the scope defined in Claims 1 to 3 of the present invention, and as a result the number of indentations on the magnetic layer was small and dropouts could be suppressed.

What is claimed is:

1. A magnetic recording medium comprising:
a support; and
at least one magnetic layer provided above the support, the magnetic layer comprising a ferromagnetic powder dispersed in a binder;
the binder of the magnetic layer comprising a binder that is obtained by a reaction between a hyperbranched polyester and an isocyanate curing agent, and the magnetic layer having an indentation hardness of 392 to 981 MPa (40 to 100 kgf/mm²).

2. A magnetic recording medium comprising:
a support and, in order thereabove;
a non-magnetic layer comprising a non-magnetic powder dispersed in a binder; and
a magnetic layer comprising a ferromagnetic powder dispersed in a binder;
the binder of the non-magnetic layer and/or the magnetic layer comprising a binder that is obtained by a reaction between a hyperbranched polyester and an isocyanate curing agent, and the magnetic layer having an indentation hardness of 392 to 981 MPa (40 to 100 kgf/mm²).

3. The magnetic recording medium according to claim 1, wherein the reaction ratio R (R=hyperbranched polyester/isocyanate curing agent) between the hyperbranched polyester and the isocyanate curing agent contained in the magnetic layer is 0.1 to 3.

4. The magnetic recording medium according to claim 1, wherein the hyperbranched polyester is a multi-branched polyester obtained by condensation of a monomer compound having two hydroxyl groups or groups derived therefrom and one carboxyl group or group derived therefrom per molecule.

5. The magnetic recording medium according to claim 4, wherein the monomer compound is one compound selected from the group consisting of dimethylolpropionic acid, dimethylolbutanoic acid, and derivatives thereof.

6. The magnetic recording medium according to claim 1, wherein the hyperbranched polyester is a multi-branched polyester obtained by condensation between a monomer compound having two hydroxyl groups or groups derived therefrom and one carboxyl group or group derived therefrom per molecule and a polyhydric alcohol as a core compound.

7. The magnetic recording medium according to claim 6, wherein the monomer compound is one compound selected from the group consisting of dimethylolpropionic acid, dimethylolbutanoic acid, and derivatives thereof, and the core compound is one compound selected from the group consisting of pentaerythritol, trimethylolpropane, and derivatives thereof.

8. The magnetic recording medium according to claim 6, wherein the nuclear compound is used at 0.01 to 0.10 mol per mol of the monomer compound.

9. The magnetic recording medium according to claim 1, wherein the amount of hyperbranched polyester added to the magnetic layer is 0.1 to 15 parts by weight relative to 100 parts by weight of the ferromagnetic powder.

10. The magnetic recording medium according to claim 1, wherein the magnetic layer has a thickness of 0.01 to 0.10 μm.

11. The magnetic recording medium according to claim 2, wherein the reaction ratio R (R=hyperbranched polyester/isocyanate curing agent) between the hyperbranched polyester and the isocyanate curing agent contained in the magnetic layer is 0.1 to 3.

12. The magnetic recording medium according to claim 2, wherein the hyperbranched polyester is a multi-branched polyester obtained by condensation of a monomer compound having two hydroxyl groups or groups derived therefrom and one carboxyl group or group derived therefrom per molecule.

13. The magnetic recording medium according to claim 12, wherein the monomer compound is one compound selected from the group consisting of dimethylolpropionic acid, dimethylolbutanoic acid, and derivatives thereof.

14. The magnetic recording medium according to claim 2, wherein the hyperbranched polyester is a multi-branched polyester obtained by condensation between a monomer compound having two hydroxyl groups or groups derived therefrom and one carboxyl group or group derived therefrom per molecule and a polyhydric alcohol as a core compound.

15. The magnetic recording medium according to claim 14, wherein the monomer compound is one compound selected from the group consisting of dimethylolpropionic acid, dimethylolbutanoic acid, and derivatives thereof, and the core compound is one compound selected from the group consisting of pentaerythritol, trimethylolpropane, and derivatives thereof.

16. The magnetic recording medium according to claim 14, wherein the nuclear compound is used at 0.01 to 0.10 mol per mol of the monomer compound.

17. The magnetic recording medium according to claim 2, wherein the amount of hyperbranched polyester added to the magnetic layer is 0.1 to 15 parts by weight relative to 100 parts by weight of the ferromagnetic powder.

18. The magnetic recording medium according to claim 2, wherein the amount of hyperbranched polyester added to the non-magnetic layer is 0.1 to 15 parts by weight relative to 100 parts by weight of the non-magnetic powder.

19. The magnetic recording medium according to claim 2, wherein the magnetic layer has a thickness of 0.01 to 0.10 μm.

20. The magnetic recording medium according to claim 2, wherein the non-magnetic layer has a thickness of 0.2 to 3.0 μm.
